(19) United States
(12) Patent Application Publication
(10) Pub. No.: US 2024/0393144 A1
(43) Pub. Date: Nov. 28, 2024

(54) Fibre Optic Cables for Sensing

(71) Applicant: OptaSense Holdings Limited, Camberley, Surrey (GB)

(72) Inventors: Robert Ellwood, Camberley, Surrey (GB); Alastair Godfrey, Camberley, Surrey (GB); Mark Carter, Camberley, Surrey (GB)

(21) Appl. No.: 18/714,718

(22) PCT Filed: Jan. 12, 2023
(86) PCT No.: PCT/GB2023/050056

§ 371 Date: May 30, 2024

(30) Foreign Application Priority Data
Jan. 31, 2022 (GB) 2201225.6

(51) Int. Cl. G01D 5/353; G02B 6/44

(52) U.S. Cl. CPC G01D 5/35361; G01D 5/35377; G02B 6/4405; G02B 6/4427

(57) ABSTRACT

This application relates to fibre optic cables structures which are particularly suited for use for distributed fibre optic sensing. A fibre optic cable structure (300, 500) is described which includes a cable core (301, 501) and a longitudinal strength member (302, 502). The cable core has at least one optical fibre (301a, 501a) and, optionally, one or more surrounding layers (505) and/or a strain transformer. (504) The cable core and is fixedly coupled to the longitudinal strength member at periodic fixed coupling points (303, 503). At the fixed coupling points the cable core has a substantially fixed position with respect to the longitudinal strength member and between the fixed coupling points the cable core is free to move with respect to the strength member. For an operating range of tensile load and pressure, the length (Lcoup) of the cable core between any two adjacent fixed coupling points is greater than the axial distance (Dcoup) along the fibre optic cable structure between the fixed anchoring points.

This application relates to fibre optic cable structures suitable for use for fibre optic sensing and to the manufacture and use of such fibre optic cable structures.

Various types of fibre optic sensing are known, in which an optical fibre is deployed in an area of interest as a sensing fibre and interrogated using optic radiation to determine information about the environment around the sensing fibre and/or stimuli acting on the sensing fibre.

One type of fibre optic sensing involves interrogating the sensing optical fibre with coherent optical radiation and detecting and analysing optical radiation which is Rayleigh backscattered from within the sensing fibre. The interrogating radiation may be Rayleigh backscattered from intrinsic scattering sites within the optical fibre that are inherently present in an optical fibre. A disturbance acting on the sensing fibre can alter the distribution of the scattering sites, leading to a detectable change in the properties of the backscatter from one interrogation to the next. The backscatter may be processed in time bins corresponding to the return trip time to different sections or sensing portions of the sensing optical fibre according to the principles of optical time domain reflectometry (OTDR), so as to provide independent sensing of a plurality of sensing portions. Such distributed fibre optic sensing may thus be termed COTDR sensing (coherent OTDR), or coherent Rayleigh distributed fibre optic sensing.

As such, COTDR sensors can utilize the backscatter from intrinsic scattering sites within the sensing optical fibre, the sensing can be performed using conventional optical fibres such as may form part of a fibre optic cable as conventionally used for telecommunications. The use of such standard, readily commercially available, fibre optic cables may be advantageous in terms of costs and can allow the use of existing fibre optic cables that may have previously been deployed in an area of interest for communications.

However, in some cases the use of standard fibre optic cable structures may have limitations when used for COTDR.

Embodiments of the present disclosure relate to fibre optic cables structures suitable for use for fibre optic sensing that may offer some advantages or improvements.

Thus, according to an aspect of the disclosure, there is provided a fibre optic cable structure comprising:
a cable core comprising at least a first optical fibre; and
a longitudinal strength member;
wherein the cable core is fixedly coupled with respect to the longitudinal strength member at periodic fixed coupling points, such that at the fixed coupling points the cable core has a substantially fixed position with respect to the longitudinal strength member and between the fixed coupling points the cable core is free to move with respect to the strength member;
and wherein, for an operating range of tensile load and pressure, the length of the cable core between any two adjacent fixed coupling points is greater than the axial distance along the fibre optic cable structure between the fixed anchoring points.

In some examples, the longitudinal strength member may comprise at least one elongate member. The longitudinal strength member may comprise at least one multi-stranded cable.

In some examples, the distance between adjacent fixed coupling points may be at least five times the cable core diameter. In some examples, the distance between adjacent fixed coupling points may be no greater than 5 metres.

The stiffness of the longitudinal strength member of the distance between adjacent fixed coupling points may be configured so that a sensitivity of the first optical fibre when used for coherent Rayleigh distributed fibre optic sensing is substantially equal in a longitudinal direction and at least one transverse direction. In some examples, the stiffness of the longitudinal strength member of the distance between adjacent fixed coupling points may be configured so that a sensitivity of the first optical fibre when used for coherent Rayleigh distributed fibre optic sensing is substantially equal in all directions. Alternatively, the relative location of the strength member and the first optical fibre and the stiffness of the longitudinal strength member of the distance between adjacent fixed coupling points may be configured so that a sensitivity of the first optical fibre when used for coherent Rayleigh distributed fibre optic sensing exhibits a preferential sensitivity for one transverse direction.

In some examples, the relative location of the first optical fibre with respect to longitudinal strength member may be configured to vary along the length of the fibre optic cable structure. One of the first optical fibre and the longitudinal strength member may be configured to follow a helical path around the other along the length of the fibre optic cable structure.

In some implementations, the cable core may comprise at least one layer of a buffer material. In some implementations the cable core may further comprise a deformable strain transformer configured to convert a radial force acting on the fibre optic cable structure into a longitudinal force on the first optical fibre. The strain transformer may comprise at least one of a helical, coiled or braided element running along the length of the cable core. The longitudinal strength member may be coupled to the strain transformer at said fixed coupling points.

In some examples, the operating range of pressure is a range of pressure greater than atmospheric pressure, e.g. a hydrostatic pressure greater than atmospheric pressure.

Another aspect is a fibre optic sensor comprising the fibre optic cable structure of any of the embodiments described herein deployed in an area of interest and a fibre optic sensing interrogator unit connected to interrogate said first optical fibre.

Another aspect is the use of a fibre optic cable structure of any of the embodiments described herein for distributed fibre optic sensing.

Another aspect is a fibre optic cable structure comprising: a cable core comprising at least a first optical fibre; and a longitudinal strength member; wherein the cable core is fixedly coupled with respect to the longitudinal strength member at periodic fixed coupling points, such that a tensile load applied to the fibre optic cable structure results in a tensile load in the longitudinal strength member without a tensile load being applied to the cable core.

In another aspect there is provided a fibre optic cable structure comprising: a cable core comprising at least a first optical fibre; and a longitudinal strength member; wherein the cable core is fixedly coupled with respect to the longitudinal strength member at periodic fixed coupling points, and wherein for an operating range of temperature and pressure the length of the cable core between any two adjacent fixed coupling points is greater than the axial distance along the fibre optic cable structure between the fixed anchoring points.

Note that unless expressly indicated to the contrary or clearly incompatible, any feature of any of the embodiments described herein may be used in combination with any one or more features of any of the other described embodiments.

Embodiments, and feature of embodiments of the present disclosure, will now be described by way of example only with respect to the accompanying drawings, of which:

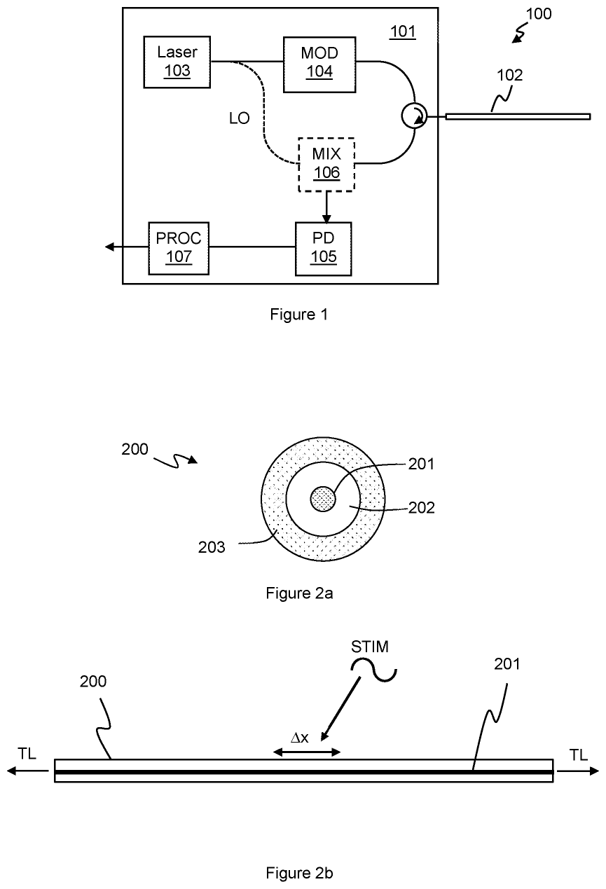

FIG. 1 illustrates one example of a coherent Rayleigh backscatter distributed fibre optic sensor;

FIGS. 2a and 2b illustrate a conventional fibre optic cable structure;

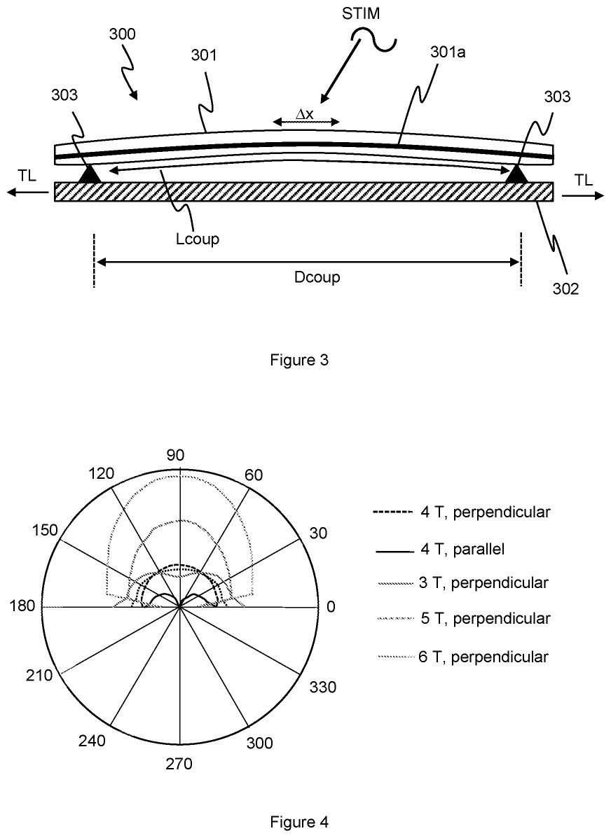

FIG. 3 illustrates a fibre optic cable structure according to an embodiment;

FIG. 4 illustrates the sensing response of a coherent Rayleigh fibre optic sensor when using a fibre optic cable structure according to an embodiment; and

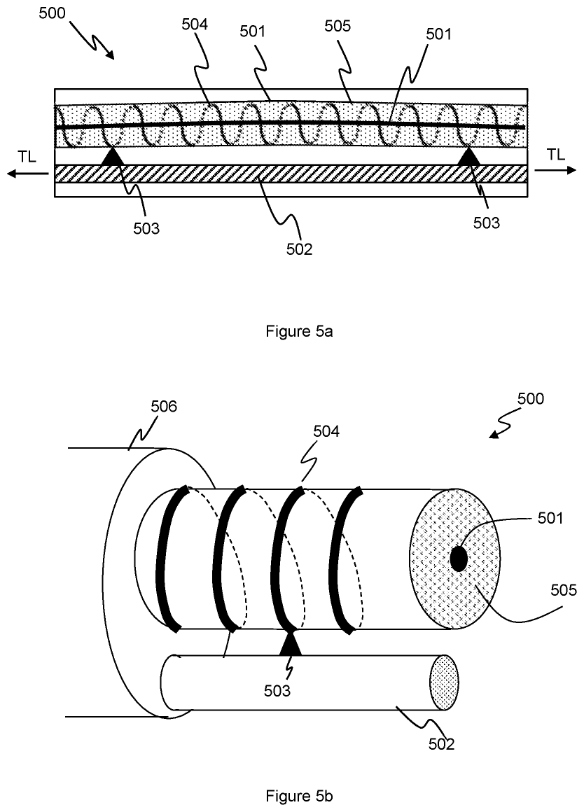

FIGS. 5a and 5b illustrate another example of a fibre optic cable structure according to an embodiment; and

Embodiments of the present disclosure relate to fibre optic cable structures suitable for use for fibre optic sensing and, in particular, for coherent Rayleigh backscatter fibre optic sensing, e.g. Rayleigh backscatter COTDR sensing.

As noted above, Rayleigh backscatter COTDR is a known technique for sensing for dynamic disturbances acting on an optical fibre.

FIG. 1 illustrates the principles of Rayleigh backscatter COTDR fibre optic sensing and illustrates generally a sensing arrangement 100. An interrogator 101 is, in use, optically coupled to an optical fibre 102 which is to be used for sensing. The optical fibre 102, may be referred to herein as the sensing optical fibre or just sensing fibre (or sometimes as the fibre under test).

The sensing fibre 102 can be many kilometres in length and can be tens of kilometres in length, say up to 40 km or more or up to 100 km or more in some implementations. For coherent Rayleigh distributed fibre optic sensing, the sensing fibre 102 may be a standard, unmodified single mode optic fibre such as is routinely used in telecommunications applications, although multimode fibre may be used in some applications (typically with reduced performance). The sensing fibre need not include any deliberately introduced reflection sites such a fibre Bragg grating or the like, but in some implementations some such reflection sites could be present, or the fibre may be one which has been fabricated or processed to provide greater scattering than a conventional telecommunications optical fibre. Note whilst the sensing fibre may be one continuous optical fibre, the sensing fibre could, in some applications, be formed from various optical fibre sections that have been spliced together or otherwise optically connected. The sensing fibre 102 will be protected by containing it with a cable structure which may contain more than one optical fibre.

In use, the interrogator 101 repeatedly interrogates the sensing optical fibre 102 with coherent optical radiation and analyses the backscatter therefrom. The interrogator 101 thus comprises an optical source, in this example a laser 103, for generating coherent optical radiation and a modulator 104 for modulating the output of the laser so as to repeatedly interrogate the sensing fibre in a series of interrogations. Note that as used herein the term “optical” is not restricted to the visible spectrum and, as used herein, the term optical refers to any electromagnetic radiation which may be guided by, and scattered from within, an optical fibre. For the avoidance of doubt, optical radiation as used herein includes infrared radiation and ultraviolet radiation. Any reference to “light” should also be construed accordingly.

The interrogating radiation may take different forms. In some examples, a single pulse of optical radiation at a given launch frequency may be used for each interrogation, although in some embodiments each interrogation may comprise two (or more) pulses, in which case the optical pulses may have different launch frequencies from one another, e.g. a frequency pattern as described in GB2,442,745 or as described in WO2020/016556, or optical characteristics such as described in WO2012/137022, the contents of each of which are hereby incorporated by reference thereto.

The phenomenon of Rayleigh backscattering results in some fraction of the interrogating radiation input into the sensing fibre being reflected back to the interrogator, where it is detected to provide an output signal which can be representative of environmental disturbances acting on the fibre. The interrogator 101 therefore comprises at least one photodetector 105 arranged to detect radiation which is Rayleigh backscattered from within the sensing fibre 102. In some embodiments the backscatter may be mixed with a local oscillator signal prior to detection, e.g. by mixer 106. The signal from the photodetector may be processed by processor 107 of the interrogator 101 to provide a measurement signal which is representative of disturbances acting on the sensing portions or channels of the fibre.

For a coherent Rayleigh distributed fibre optic sensor, the backscatter from the sensing optical fibre 102 will depend, at least partly, on the distribution of inherent scattering sites within the optical fibre, which will vary effectively randomly along the length of the fibre. Thus the backscatter characteristics, e.g. intensity, from any given interrogation will exhibit a random variation from one sensing portion to the next but, in the absence of any environmental stimulus, the backscatter characteristics from any given sensing portion should remain the same for each repeated interrogation (provided the characteristics of the interrogating radiation, such as the optical frequency, amplitude and duration of the pulse or pulses, remains the same for each interrogation). However, an environmental stimulus acting on the relevant sensing portion of the fibre can result in an optical path length change for that section of fibre, e.g. through stretching/compression of the relevant section of fibre and/or a refractive index modulation. As the backscatter from the various scattering sites within the sensing portion of fibre will interfere to produce the resulting intensity, a change in optical path length will vary the degree of interference. The variation in distribution of the scattering sites will result in a variation in intensity of backscattered from an affected sensing portion, which can be detected and used as an indication of a disturbance acting on the fibre, such as an incident acoustic wave.

For a phase based coherent Rayleigh distributed fibre optic sensor the processing by processor will generally determine a phase value from the backscattered light, e.g. the phase of a signal component at at least one defined carrier frequency. A signal component at a defined carrier frequency can be generated in various ways. For instance, as discussed above, each interrogation may comprise two optical pulses at different optical frequencies to one another, where the frequency difference between the pulses defines the carrier frequency. In such a case, backscatter from both pulses may interfere to provide a signal component at the carrier frequency. Alternatively, backscatter from a pulse at a given optical frequency may be mixed with a local oscillator signal LO, where the optical frequency of the local oscillator differs from that of the backscatter by the defined carrier frequency. The processor 107 may thus demodulate the signal from the photodetector 105 at the relevant carrier frequency to provide a value of phase for the carrier signal, as would be understood by one skilled in the art, for instance as described in any of GB2,442,745, WO2012/137021, WO2012/137022 or WO2020/016556, depending on the form of the interrogating radiation.

Any disturbance acting on the sensing fibre that results in a change in the optical path length of that part of the sensing fibre will result in a modulation to the phase of the carrier signal over that sensing portion, where the extent of the change in phase is proportional to the change in path length. Thus, a stimulus acting on the sensing fibre can be detected by determining the extent of any phase modulation between repeated interrogations of the sensing fibre, and the magnitude of the phase modulation provides an indication of magnitude of the stimulus acting on the sensing fibre.

The form of the optical input and the method of detection and processing allows the sensing fibre to be spatially resolved into discrete longitudinal channel or sensing portions with a desired gauge length. That is, a measurement signal indicative of disturbance at one sensing portion, e.g. indicative of an incident acoustic wave, can be provided substantially independently of a measurement signal for another sensing portion. Note that the term acoustic, as used herein, shall be taken to mean any type of pressure wave or mechanical disturbance or varying strain generated on the optical fibre and will, for instance, include seismic waves or the like. The term acoustic is intended to refer to the type of stimulus acting on the sensing fibre but is not used to imply any particular frequency limitation.

As noted above, the sensing fibre 102 may be a standard optical fibre such as routinely used for telecommunications. The optical fibre will generally be disposed in a cable structure for protection and thus coherent Rayleigh distributed fibre optic sensing may be performed using commercially available fibre optic cables such as may be used for telecommunications.

FIG. 2a illustrates generally one example of a known type of fibre optic cable 200 that could be used to provide the sensing fibre. FIG. 2a illustrates a cross section through the fibre optic cable. The fibre optic cable 200 comprises least one optical fibre 201, which will typically comprise a core and cladding and possibly a fibre jacket as will be well understood by one skilled in the art. In some cable designs there may be more than one optical fibre 201. The optical fibre(s) 201 may be located within at least one buffer material 202 for protection of the optical fibre. In some fibre optic cables the buffer may be a material that is tightly bound to the optical fibre(s) of the cable but other designs are known including gel filled cables where the gel provides at least part of the buffer. At least one outer jacket material 203 may be provided to give environmental protection, e.g. to make the cable watertight and/or gas impermeable.

One skilled in the art will, of course, appreciate that there are a variety of fibre optic cable designs and in other designs there may be one or more armour or protective layers to provide protection of the optical fibre(s) 201. In some applications, a suitable armour layer may be an aramid layer or braided metallic shield, or may comprise stranded steel wires or the like. Additionally or alternatively, in some designs there may be more buffer layers and/or jacket layers of different materials.

For such fibre optic cables, an elastic/acoustic wave incident on the fibre optic cable may cause a change in length due to the Poisson's ratio of the bulk material of the fibre optic cable, i.e. the solid buffer/jacket layers surrounding the optical fibre. This change in length of the bulk material can be imparted to the optical fibre, causing a change in optical path length.

The use of standard telecommunication cables, such as illustrated in FIG. 2a, may be advantageous in some applications, in allowing the use of existing cables previously deployed in an area of interest or allowing deployment of readily commercially available fibre optic cables. However, there may be some limitations in terms of sensitivity when using conventional fibre optic cables for coherent Rayleigh fibre optic sensing, i.e. Rayleigh backscatter COTDR.

In particular, the deployment of fibre optic cables, especially relatively long fibre optic cables such as may be useful for distributed fibre optic sensing, e.g. of the order of several hundreds of metres or kilometres in length, may generally involve the cable being pulled into position. The deployed fibre optic cable may then be continuously pinned in place by friction with the surrounding medium and/or, in some cases, may be secured in place. Typically, this results in the fibre optic cable being in a state of tension when deployed. In particular, the components of the fibre optic cable structure that provide the dominant stiffness of the fibre optic cable will generally be in a state of tension, for example the cable outer sheath and any armour layer or other components that provide stiffness.

Such a fibre optic cable deployment is disadvantageous as the tension of the cable structure, and possibly the optical fibre within the cable structure, effectively means that, for incident waves that would tend to cause a change in length of the fibre optic cable, due to the Poisson ratio of the material of the fibre optic cable, there is a force that needs to be overcome in order to effect a change in length, and hence a change in path length of the optical fibre. As mentioned above, coherent Rayleigh fibre optic sensing is responsive to changes in optical path length of the sensing fibre. Thus, any incident stimulus needs to be sufficiently large to overcome the tension in the optical cable and fibre before any measurement signal can be detected via the Rayleigh COTDR sensing.

FIG. 2b illustrates this principle. FIG. 2b illustrates, an example of a conventional fibre optic cable 200 comprising an optical fibre 201 and buffer/jacket layers, such as described with reference to FIG. 2a. As discussed above, conventional deployment techniques may result in the deployed fibre optic cable being under a deployment tensile load TL. In particular the bulk material of the fibre optic cable, such as an outer jacket layer, and possibly any solid buffer layers, may be in tension. If, in use, a stimulus STIM, such as an acoustic/elastic wave, were to act on the fibre optic cable 200, so as to tend to cause expansion or contraction of the fibre optical cable, and hence the optical fibre 201, the longitudinal force may just act to relieve the tensile load. Thus, the relevant part of the fibre optic cable may go from an initial state of high tension to being a state of medium or low tension. However, unless the longitudinal force were sufficient to completely overcome the tensile load TL, there would be no change in path length Δx of the optical fibre 201.

This issue can be exacerbated if such a conventional fibre optic cable structure is deployed underwater, as hydrostatic pressure acting on a conventional fibre optic cable structure tends to cause contraction of the fibre optic cable. Thus, if at least part of a conventional fibre optic cable is deployed underwater, the additional pressure causes contraction of the fibre optic cable that can lead to, or increase, deployment tension in the fibre optic cable, and possibly in the sensing optical fibre, with the extent of the contraction increasing with pressure and hence depth.

Embodiments of the present disclosure relate to fibre optic cable structures that can, at least partly, mitigate for any tensile load that may introduced during normal cable deployment and/or arise for the operating environment, e.g. underwater. Fibre optic cables according to embodiments are thus configured such that, when deployed, an optical fibre and surrounding bulk material of the fibre optic cable structure may not be under any significant tension and may, advantageously, be substantially unloaded or tension free, even though part of the fibre optic cable structure as a whole may be subject to a non-zero tensile load (within an operating range of expected tensile load due to cable deployment and pressure on the fibre optic cable structure).

In at least some embodiments of the present disclosure, a fibre optic cable structure comprises a cable core with at least one optical fibre and at least one longitudinal strength member, wherein the cable core is fixedly coupled with respect to the longitudinal strength member at periodic fixed coupling points but substantially decoupled from the longitudinal strength member between the periodic fixed coupling points.

The cable core comprises at least one optical fibre. In some cases, the cable core may just comprise an optical fibre, but in at least some embodiments the cable core comprises at least one optical fibre together with one or more additional layers, e.g. buffer, armour and/or jacket layers, for instance such as described with respect to FIG. 2a. In some instances the cable core could be a conventional fibre optic cable, which is then fixedly coupled to the longitudinal strength member to provide the fibre optic cable structure. Thus the strength member could be external to the fibre optic cable but coupled thereto. In some implementations, however, the cable core and strength member may be both within some outer covering of the fibre optical cable structure, in which case the cable core may comprise one or more optical fibres and one or more layers of material as may be used in a conventional fibre optic cable, e.g. for protection of the optical fibres. For example the cable core may comprise at least buffer layer, and possibly one or more jacket layers and/or some armouring. The cable core will thus comprise at least one optical fibre that can be used as an optical fibre for sensing and at least some surrounding material that is able to deform in response to an incident stimulus to cause a change in optical path length of the optical fibre.

At the fixed coupling points, the cable core is fixedly coupled with respect to the strength member, such that cable core has a substantially fixed position with respect to the strength member, thus any movement of the strength member at the fixed coupling points will also translate to a movement of the cable core. The fixed coupling points are thus pinning or anchoring points for the cable core. However, between the fixed coupling points the cable core is substantially unconstrained with respect to the strength member, and thus may be free to move with respect to the strength member. As will be discussed in more detail below, the cable core may be coupled to the strength member in a number of different ways, e.g. by direct connection or use of some linkage.

The strength member is configured so as, in use, to take the load of deployment of the fibre optic cable structure, at least within an expected operating range of tensile load. Thus, in use of fibre optic cable according to an embodiment, the strength member of the fibre optic cable structure may be under a tensile load when deployed. However, the cable core is coupled to the strength member such that this tensile load of deployment is substantially not transferred to the cable core. The cable core may be fixedly coupled with respect to the strength member such that the length of the cable core between any two adjacent fixed coupling points is greater than the axial distance along the fibre optic cable structure between the fixed anchoring points (along the axis of the fibre optic cable structure) for the fibre optic cable structure for a tensile load within an operating range. In other words, when deployed the length of cable core between any two fixed coupling points is greater than the axial separation of the two fixed coupling points, i.e. there is some ‘slack’ in the first cable core.

FIG. 3 illustrates this principle. FIG. 3 illustrates a fibre optic cable structure 300 according to an embodiment, which includes at least a cable core 301 which comprises at least one optical fibre 301a surrounded by some bulk material, e.g. by one or more buffer/protective layers. In this case the fibre optic cable structure also comprises a strength member 302 which is coupled to the cable core 301 at a plurality of spaced fixed coupling points. As noted above, the cable core 301 is pinned or anchored to move with the strength member 302 at the fixed coupling points 303, but between the fixed coupling points 303, the cable core 301 is able to move with respect to the strength member 302. The strength member is configured to take the load of deployment and thus, when deployed, the strength member 302 may be under some tensile load. However, in this example, the fibre optic cable structure 300 is configured such that, when deployed under an expected deployment load and pressure, i.e. within a predefined expected operating range, the longitudinal distance Dcoup between two fixed coupling points 303 is less than the length Lcoup of the cable core 301 between these coupling points, i.e. there is a greater length of cable core 301 than the axial length of the strength member 302 between the two fixed coupling points. As such the cable core itself is substantially unloaded as a result of deployment.

In this case, if, in use, a stimulus STIM, such as an acoustic/elastic wave, were to act on the cable structure 300, and hence the cable core 301, then as the cable core 301 is not, itself, under tension, there is no significant pre-existing tensile load to overcome before any expansion of the cable core, with a resultant change in optical path length of the optical fibre 301a. The parts of the cable core 301 that are away from the fixed coupling points 303 would be free to move/expand, resulting in a change of path length Δx in the optical fibre 301a, which can lead to detectable measurement signal if Rayleigh COTDR is being performed on the optical fibre 301a. Using the optical fibre 301a of the fibre optic cable structure 300 for coherent Rayleigh backscatter fibre optic sensing can thus enable a more sensitive fibre optic sensor than using a convention fibre optic cable structure 200. A fibre optic sensor using the first optical fibre 301a of the fibre optic cable structure 300 will generally produce a stronger measurement signal for incident stimuli than the conventional fibre optic cable structure 200 and will also allow detection of incident stimuli that would not be detectable using an optical fibre of the conventional fibre optic cable structure 200. In particular, the fibre optic cable structure of embodiments of the disclosure may exhibit a significantly increased sensitivity for waves propagating transversely with respect to the cable axis, i.e. for broadside signal, where a change in path length may arise due to the Poisson effect in the bulk material of the fibre optic cable core.

It will be noted that it is the parts of cable core 301, and hence optical fibre 301a that are located away from the coupling points 303 and which are able to move with respect to the strength member 302 that provide the signal of interest when used for Rayleigh COTDR. In some previous applications of fibre optic sensing, a conventional cable structure may be coupled to an object in the area of interest to provide a strong acoustic coupling between the cable and the object at the coupling points.

As mentioned above the strength member 302 is designed to take the load of deployment of the cable. The strength member 302 may thus have a stiffness which is sufficient to take the expected tensile load of deployment, without passing any substantial tensile load to the cable core, for example the strength member 302 may be configured to undergo a limited amount of elongation for the tensile loads in an operating range expected during conventional deployment. However, the axial stiffness of the strength member may have an impact on the responsiveness of the optical fibre 301a of the cable core 301 to any pressure waves propagating axially along the fibre optic cable structure, with the sensitivity to such axial stimuli decreasing with increasing stiffness of the strength member. There may, therefore, be a trade-off between longitudinal and transverse sensitivity, with an increasing stiffness of the strength member reducing longitudinal sensitivity, i.e. to waves propagating along the axis/length of the cable structure, but increasing transverse sensitivity, i.e. to waves propagating perpendicularly to the axis of the cable structure. The strength member thus may have a stiffness which is sufficient to take the load of deployment, without any tensile loading, or at least without any substantial tensile loading, being applied to the coupled first optical fibre, but which is not too high so as to prevent response to axial stimuli or ‘endfire’ signals. Advantageously, however, the strength member 302 may be one which allows at least some flexibility of the fibre optic cable structure. A suitable stiffness for the strength member, or range of stiffness, may depend on the type of strength member and on the rest of the fibre optic cable design, as well as the intended use case, e.g. as a buried cable or an underwater cable etc. One skilled in the art would be able to determine a suitable range of stiffness for the strength member, for instance by modelling and/or testing of various designs.

In some implementations the strength member could comprise at least one elongate member, such as a steel cable or the like. At least one elongate member could comprise a metallic material, and/or a fibre composite or aramid material. The strength member 302 may be arranged to run along substantially the whole length of the fibre optic cable structure. Note that FIG. 3 illustrates a fibre optic cable structure 300 with a single continuous strength member, but in some implementations the strength member could comprise a plurality of different elements, e.g. multiple steel cables and/or the fibre optic cable structure could comprise multiple strength members. In some implementations, a multi-strand cable, e.g. a multi-strand steel cable, may be advantageously used as a strength member, as the axial stiffness can be high, but the bending stiffness can be relatively low, which can ease deployment.

As noted above, in some embodiments, the first fibre optic could be formed within a fibre optic cable, e.g. of the type illustrates in FIG. 2a with one or more buffer layers, and the fibre optic cable used as the cable core 301, with the strength member coupled externally to the fibre optic cable. Thus, for example, a strength member such as a steel cable or the like could run along the outside of the fibre optic cable and be coupled to the outer jacket of fibre optic cable at the fixed coupling points so as to fixedly couple the strength member to the optical fibre via the jacket and buffer layers. It will, of course, be understood that the strength member will be attached to fibre optic cable to provide a fibre optic cable structure according to embodiments of the disclosure prior to deployment in an environment so as to provide the benefits of the strength member taking the tensile load arising from deployment.

Preferably, however, the fibre optic cable structure should have a relatively smooth and continuous outer surface so as to aid in deployment and thus it is preferably that the strength members forms part of the interior of the fibre optic cable structure. The strength member 302 and the cable core 301 may thus be arranged such that at least one jacket layer surrounds both the strength member 302 and the first optical fibre 301.

There are a variety of ways in which a cable core could be fixedly coupled to the strength member.

For instance, the strength member and cable core could be formed separately and attached at the required intervals by clamping, strapping or tying or the like, or attached by some other bonding, e.g. welding or adhesion or the like.

In some examples, the cable core and strength member could be manufactured so as to be initially substantially continuously coupled together along their lengths, and then processed so as to decouple the strength member from the cable core between the desired coupling points. For instance, the cable core could be separated from a bonded strength cable by cutting between the desired fixed coupling points, e.g. using a notched cutting disk or the like. In some cases, the strength member and cable core could be co-extruded within a jacket layer and a webbing between the strength member and the cable core cut at defined sections to provide the decoupled portions between fixed coupling points.

In some examples, at least some of the coupling between the strength member and the cable core could be provided by one or more over-coating layers that cover the cable core and the strength member. For instance, the strength member and cable core could be overcoated with a coating material that provide bonding in an extrusion process, but with a decoupling coating material applied over lengths of the cable core/strength member. The decoupling material may be deployed to prevent bonding of strength member to the cable core over the relevant sections. The decoupling material may then be later removed to leave the cable core bonded to the strength member only at the fixed coupling points between the decoupled sections. Alternatively, the over-coating could be applied to in a way that leaves an air gap in-between the coupling points.

The coupling of the cable core to the strength member may be performed with the strength member subject to a tensile load, which may for example be a tensile load similar that which may expected followed deployment of the fibre optic cable structure, whilst the cable core is subject to no significant tensile loading.

Additionally or alternatively, one or more environmental parameters could be controlled so that, during bonding, the strength member experiences a differential expansion compared to the cable core. For instance, the temperature of the strength member and/or the cable core may be controlled to a value outside the expected operating range in use and which induces a differential thermal length change. For example, the strength member could be heated to cause expansion prior to bonding to the cable core. Subsequently, when the strength member cools and contracts, the length of the cable core between the coupling points may be greater than length of the strength member between the coupling points.

As noted above, it is the ability of the optical fibre of the cable core at locations between the fixed coupling points to readily move and expand in response to incident pressure/elastic waves that provides the advantageous sensing capability. The separation Dcoup between the fixed coupling points should thus be large enough to allow the optical fibre of the cable core to be able to respond to incident signals, and to avoid the cable structure being effectively under compression or unable to bend. In some applications, the distance Dcoup between the coupling points may be at least a few centimetres or more, e.g. the distance between coupling point may be at least 50 mm or more, or in some cases at least 100 mm or more, though this is dependent of the cable stiffness. The distance Dcoup between the fixed coupling points may depend on the properties of the fibre optic cable structure, for instance the stiffness of the longitudinal strength member. The longitudinal strength member should provide a sufficient stiffness between the fixed coupling points to prevent tension of the cable core. In some cases the distance Dcoup between the fixed coupling points may be no greater than several metres, e.g. 5 m or less or is some cases 2 m or less. In some cases the distance Dcoup between the fixed coupling points may be determined based on a particular sensing application for which the fibre optic cable structure is intended. Likewise the amount of excess optical fibre, i.e. the difference between the fibre length Lcoup between the coupling points and the axial separation Dcoup between the coupling points may be determined based on a particular application, but in some cases the difference could be in the range of 0.2-5% or so.

It will be understood that the distance Dcoup between the fixed coupling point can be independent of the gauge length used for sensing when using the fibre optic cable structure. In other words, the gauge length used for sensing could be greater or smaller than the separation Dcoup between the fixed coupling portions. If the gauge length is greater than the separation Dcoup between the fixed coupling portions, each sensing portion of the optical fibre will comprise at least one and possible several fixed coupling portions. If the gauge length is smaller than the separation Dcoup between the fixed coupling portions, there can be some sensing portions of the optical fibre that will not comprise any fixed coupling portion.

It should also be noted that the separation between the fixed coupling portions may conveniently be substantially constant along the length of the fibre optic cable structure, as this can provide relatively uniform cable properties and may simplify manufacture. However, it would be possible for the axial distance between at least some successive fixed coupling points to be different to the axial distance between at least some other successive fixed coupling points. Thus, the periodic coupling points may be spaced at regular or at irregular intervals. It will thus be understood that, as used herein, the term periodic should not be taken as implying any regularity to the spacing of the coupling points, although in some examples the intervals may be regular.

By appropriate choice of strength member and fixed coupling points the sensitivity of the fibre optic cable structure can be tuned to provide a desired response when used for sensing.

FIG. 4 illustrates a polar plot of responsivity of a fibre optic when used for Rayleigh COTDR for different designs of fibre optic cable structure, with different thicknesses T of strength member. It can be seen that as the thickness, and so stiffness, of the strength member varies, so too does the sensitivity of the fibre optic of the fibre optic cable structure to transverse, i.e. broadside, waves.

For a fibre optic cable structure such as illustrated in FIG. 3, a preferential radial sensitivity may be observed dependent on the location of the strength member, in general the radial sensitivity will be reduced in the direction where the strength member is located.

In some applications such a preferential radial sensitivity may be useful, but in some applications, where a more omnidirectional radial response is preferred, the relative location of the strength member with respect to the first optical fibre could vary along the length of the fibre optic cable structure, for instance one of the strength member and first optical fibre could follow a helical path around the other within the fibre optic cable structure, with the helix length being shorter than the gauge length to be used for sensing.

By appropriate choice of the parameters for the fibre optic cable structure it is also possible to provide a similar sensitivity for pressure waves propagating radially to the cable as for pressure waves propagating longitudinally along the cable, i.e. to provide a substantially equal omnidirectional sensitivity for incident acoustic/elastic waves from any direction. A fibre optic cable structure that provides an equal omnidirectional response for transverse and longitudinal stimuli represents a novel aspect of the present disclosure.

In some embodiments, the cable core may also comprise at least one deformable strain transformer configured to convert a radial force acting on the fibre optic cable structure into a longitudinal force, for instance a strain transformer such as described in WO2016/055787.

WO2016/055787 describes that conventional fibre optic cables may be preferentially sensitive to pressure waves that are propagating in a direction longitudinally along the fibre and describes that fibre optic cables may be fabricated with a deformable strain transformer which is configured to convert a radial force acting on the fibre optic cable into a longitudinal force so as to provide a desired response to pressure waves propagating perpendicular to the cable axis, i.e. propagating transversely or radially.

At least a portion of the strain transformer has a shape with a resting longitudinal length (in the absence of any external force applied to the cable) and the strain transformer is configured such that deformation of the strain transformer in response to a force transverse to the cable axis over a first portion of the cable causes a change in the longitudinal length of strain transformer. By longitudinal length is meant a dimension of the strain transformer along the cable axis. WO2016/055787 describes various types of deformable strain transformer, and in one example the strain transformer may comprise a helical or similarly coiled member or element that is substantially helical or generally coiled about an axis that is parallel to the longitudinal cable axis. The strain transformer may, for instance, comprise a helical braid element.

Fibre optic cable structures, such as described in WO2016/055787, which include a strain transformer for converting a transverse force acting on the fibre optic cable to a longitudinal force, can provide a better sensitivity to transverse signals than conventional fibre optic cables, such as discussed with reference to FIG. 2. However, the problem of deployment resulting in a tensile load in the fibre optic cable, which thus restricts the freedom of the optical fibre of a such a cable to move/expand in response to an incident pressure wave, also applied to such a cable. The principles of the present disclosure, of using a strength member to take the load of deployment, where the strength member is fixedly coupled to the cable core at periodic intervals can also be advantageously applied to a fibre optic cable structure including a strain transformer such as described in WO2016/055787 as part of the cable core.

FIG. 5a illustrates an embodiment of a fibre optic cable structure 500 according to an embodiment that include a strain transformer in side-sectional view and FIG. 5b illustrates the fibre optic cable structure in a perspective cut-away view.

The fibre optic cable structure 500 includes a cable core 501 with at least a first optical fibre 501a, and also a strength member 502 coupled to the cable core 501 at fixed coupling points 503, as discussed above with reference to FIG. 3.

In this embodiment, however, the cable core 501 also comprises a strain transformer 504 which, in this embodiment comprises a coiled member wound around a compliant material 505 surrounding the first optical fibre 501a. In this example, the first optical fibre 501a is tightly buffered to the compliant material 505 such that a dynamic longitudinal strain applied to the compliant material 505 will induce a longitudinal strain in the optical fibre. The compliant material 505 may comprise at least one layer of buffer material. The coiled strain transformer 504 may be tightly bound to the compliant material 505 to effectively grip the compliant material 505 so that the compliant material moves with the strain transformer. In some embodiments however the strain transformer may additionally or alternatively be anchored to the compliant material at various anchor points and/or at least part of the coiled member 504 may be embedded within the compliant material. The coiled member in this example is coiled around the longitudinal cable axis in a generally helical fashion.

The coiled member of the strain transformer 504 is stiffer than the compliant core material 505 but is deformable in a radial direction in response to a dynamic transverse strain. Due to the helical winding, such deformation of the coiled member 504 results in a radial or diametrical change which translates into a longitudinal length change, as described in WO2016/055787.

Whilst the strain transformer is stiffer than the compliant material, it is designed to deform in response to incident pressure waves of interest and, if subject to a significant tensile load during deployment, would transfer such loading to the optical fibre 501a.

In the embodiment of FIGS. 5a and 5b, the strength member 502 is thus fixedly coupled to the strain transformer 504 of the cable core at a plurality of fixed coupling points, and hence, via the strain transformer and compliant material 505, to the first optical fibre 501. The strength member 502 is, as discussed previously, configured to take any load of deployment without transferring the tension to the cable core 501 including, in this case, the strain transformer. As such, in use, the strain transformer is free to experience a length change, which may be expressed as local bending, in a way that would be inhibited by a tensile pre-load.

Such a fibre optic cable structure may particularly be advantageous for application where at least part of the fibre optic cable structure is intended to be deployed underwater, and thus the operating range of pressure is greater than atmospheric pressure. Fibre optic cables including strain transformers such as described in WO2016/055787 have the property that they tend to expand in length with increasing hydrostatic pressure, in contrast to conventional fibre optic cables that contract with increasing hydrostatic pressure. This means that if a fibre optic cable structure having a cable core including a strain transformer periodically coupled to a strength member such as the embodiment discussed with reference to FIGS. 5a and 5b is deployed at depth underwater, the strain transformer will automatically tend to expand as the depth increases, reducing or eliminating any tensile loading in the strain transformer, and hence optical fibre 501, due to deployment. This can simplify the manufacturing process as the expansion of the strain transformer automatically provides the degree of slack in the cable core between the coupling points so the slack does not need to be present at the time of manufacture, which may typically occur at atmospheric pressure.

In this example the cable core 501 and strength member 502 may be within an outer cover layer 506 which, as discussed may be configured to provide a uniform outer surface whilst allowing the decoupling of the strength member and cable core between the fixed coupling points 503.

Embodiments of the present disclosure thus relate to fibre optic cable structures that are suitable for use for fibre optic sensing, in particular for Rayleigh backscatter distributed fibre optic sensing. Fibre optic cable structures according to embodiments are configured so as to be able to be deployed using conventional fibre optic cable deployment techniques, that may result in some tensile loading of the fibre optic cable, but include components so as to avoid or relieve any tension on a cable core comprising at least a first optical fibre that can be used for sensing. The fibre optic cable structure thus includes a strength member configured to take any tensile load of deployment, where the strength member is coupled to the cable core at intervals at fixed coupling points, but where between the fixed coupling points the cable core is substantially decoupled from the strength member and able to move with respect to strength member and where, at an expected deployment tensile load and pressure (and operating temperature), the length of cable core between successive fixed coupling points is greater than the longitudinal distance between those successive fixed coupling points, i.e. these is some ‘slack’ in the cable core.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A fibre optic cable structure comprising:
a cable core comprising at least a first optical fibre; and
a longitudinal strength member;
wherein the cable core is fixedly coupled with respect to the longitudinal strength member at periodic fixed coupling points, such that at the fixed coupling points the cable core has a substantially fixed position with respect to the longitudinal strength member and between the fixed coupling points the cable core is free to move with respect to the strength member; and
wherein, for an operating range of tensile load and pressure, the length of the cable core between any two adjacent fixed coupling points is greater than the axial distance along the fibre optic cable structure between the fixed anchoring points.

2. The fibre optic cable structure of claim 1 wherein the longitudinal strength member comprises at least one elongate member.

3. The fibre optic cable structure of claim 1 wherein the longitudinal strength member comprises at least one multi-stranded cable.

4. The fibre optic cable structure of claim 1 where the distance between adjacent fixed coupling points is at least five times the cable core diameter.

5. The fibre optic cable structure of claim 1 where the distance between adjacent fixed coupling points is no greater than 5 metres.

6. The fibre optic cable structure of claim 1 where the stiffness of the longitudinal strength member of the distance between adjacent fixed coupling points is configured so that a sensitivity of the first optical fibre when used for coherent Rayleigh distributed fibre optic sensing is substantially equal in a longitudinal direction and at least one transverse direction.

7. The fibre optic cable structure of claim 1 where the stiffness of the longitudinal strength member of the distance between adjacent fixed coupling points is configured so that a sensitivity of the first optical fibre when used for coherent Rayleigh distributed fibre optic sensing is substantially equal in all directions.

8. The fibre optic cable structure of claim 1 wherein the relative location of the first optical fibre with respect to longitudinal strength member is configured to vary along the length of the fibre optic cable structure.

9. The fibre optic cable structure of claim 1 wherein one of the first optical fibre and the longitudinal strength member is configured to follow a helical path around the other along the length of the fibre optic cable structure.

10. The fibre optic cable structure of claim 1 wherein the relative location of the strength member and the first optical fibre and also the stiffness of the longitudinal strength member of the distance between adjacent fixed coupling points is configured so that a sensitivity of the first optical fibre when used for coherent Rayleigh distributed fibre optic sensing exhibits a preferential sensitivity for one transverse direction.

11. The fibre optic cable structure of claim 1 wherein the cable core comprises at least one layer of a buffer material.

12. The fibre optic cable structure of claim 1 wherein the cable core further comprises a deformable strain transformer configured to convert a radial force acting on the fibre optic cable structure into a longitudinal force on the first optical fibre.

13. The fibre optic cable structure of claim 12 wherein the strain transformer comprises at least one of a helical, coiled or braided element running along the length of the cable core.

14. The fibre optic cable structure of claim 10 wherein the longitudinal strength member is coupled to the strain transformer at said fixed coupling points.

15. The fibre optic cable structure of claim 1 wherein the operating range of pressure is a range of pressure greater than atmospheric pressure.

16. A fibre optic sensor comprising the fibre optic cable structure of claim 1 deployed in an area of interest and a fibre optic sensing interrogator unit connected to interrogate said first optical fibre.

17. The use of the fibre optic cable structure of claim 1 for distributed fibre optic sensing.

18. A fibre optic cable structure comprising:
a cable core comprising at least a first optical fibre; and
a longitudinal strength member;
wherein the cable core is fixedly coupled with respect to the longitudinal strength member at periodic fixed coupling points, such that a tensile load applied to the fibre optic cable structure results in a tensile load in the longitudinal strength member without a tensile load being applied to the cable core.

19. A fibre optic cable structure comprising:
a cable core comprising at least a first optical fibre; and
a longitudinal strength member;
wherein the cable core is fixedly coupled with respect to the longitudinal strength member at periodic fixed coupling points, and wherein for an operating range of temperature and pressure the length of the cable core between any two adjacent fixed coupling points is greater than the axial distance along the fibre optic cable structure between the fixed anchoring points.
